(19) United States
(12) Patent Application Publication
(10) Pub. No.: US 2025/0000241 A1
(43) Pub. Date: Jan. 2, 2025

(54) DOG TRAINING KIT

(71) Applicant: CATHLEEN LOUISE MUTNICK, Uxbridge, MA (US)

(72) Inventor: CATHLEEN LOUISE MUTNICK, Uxbridge, MA (US)

(21) Appl. No.: 18/748,936

(22) Filed: Jun. 20, 2024

Related U.S. Application Data
(60) Provisional application No. 63/510,484, filed on Jun. 27, 2023.

(51) Int. Cl. A45F 3/00; A01K 15/02

(52) U.S. Cl. CPC A45F 3/005; A01K 15/02; A45F 2003/003

(57) ABSTRACT

A dog training kit for training young dogs at home, such as puppies. The dog training kit includes a bag body that can be worn by a pet owner. The bag body has five pockets for storing different tools and articles needed for training the dog, the different tools and articles can be stored in an organized manner. The trainer can quickly draw a tool or article from the bag during training, immediately interrupting or rewarding the behavior.

### CROSS-REFERENCE TO RELATED APPLICATIONS

This application claims priority from a U.S. Provisional Patent Appl. No. 63/510,484, filed on Jun. 27, 2023, which is incorporated herein by reference in its entirety.

### FIELD OF INVENTION

The present invention relates to a dog training kit, and more particularly, the present invention relates to a hand-free puppy training kit.

### BACKGROUND

Domesticated canines are generally not trained before they are taken as pets by people. The dog owner typically must introduce the pet to its new home and surroundings, and the dog is trained to adjust to the new environment. Young puppies beginning at 8 weeks old do not know how to live in a human world. Puppies learn during every waking moment from the day they are brought home. The owner must teach the puppy what behaviors are acceptable and unacceptable. This is especially important in the first 16 weeks of a puppy's life—the development stage in which young puppies soak up new information like furry sponges. What a puppy learns or does not learn during this stage can impact behavior for the rest of his life.

Training a puppy often seems overwhelming to most owners because they set the pup free throughout the house and then wonder why their carpets become stained, the other pets are anxious, and the kids are crying about the puppy jumping on them, scratching them, biting them during play and stealing their toys. None of this is the puppy's fault. The pup simply needs to learn what he is allowed and not allowed to do, in the house, in the yard, and in public.

This is easily accomplished when the owner understands two important training needs: 1. Close supervision, and 2. Praising good behavior or interrupting unwanted behavior within a split second of the action. However, teaching puppies can seem quite laborious if an owner doesn't have the necessary training tools and instruction. A variety of training instruments are needed, and many such things are scattered in different places or may not be available in the home.

There is an overwhelming need for a puppy training kit that includes all training tools in one convenient place, within the owner's reach, at any given moment's notice.

It is to be noted that the terms pet owner, owner, pet parent, and trainer are interchangeably used hereinafter and generally refer to any person in the care of a pet.

### SUMMARY OF THE INVENTION

The following presents a simplified summary of one or more embodiments of the present invention to provide a basic understanding of its need and intention. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a kit for training dogs, especially puppies, at home.

Another object of the present invention is that the kit provides most of the tools needed to train a dog within the reach of the owner.

Still, another object of the present invention is that the kit can be worn keeping the owner's hands free.

### BRIEF DESCRIPTION OF DRAWINGS

The accompanying figures, which are incorporated herein, form part of the specification and illustrate embodiments of the present invention. Together with the description, the figures further explain the principles of the present invention and enable any Owner or Trainer to use the invention.

FIG. 1 shows a front view of the dog training kit, according to an exemplary embodiment of the present invention.

FIG. 2 shows a front and side perspective view of the dog training kit, according to an exemplary embodiment of the present invention.

FIG. 3 shows a side view of the dog training kit, according to an exemplary embodiment of the present invention.

FIG. 4 shows a rear and side perspective view of the dog training kit, according to an exemplary embodiment of the present invention.

FIG. 5 shows the rear view of the dog training kit, according to an exemplary embodiment of the present invention.

FIG. 6 shows a rear and side perspective view of the dog training kit, according to an exemplary embodiment of the present invention.

FIG. 7 shows a side view of the dog training kit, according to an exemplary embodiment of the present invention.

FIG. 8 shows a front and side perspective view of the dog training kit, according to an exemplary embodiment of the present invention.

FIG. 9 shows a top view of the dog training kit, according to an exemplary embodiment of the present invention.

FIG. 10 shows a bottom view of the dog training kit, according to an exemplary embodiment of the present invention.

FIG. 11 shows another embodiment of the dog training kit, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, tools, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to a dog training kit that can be used in the training of dogs of any age at home. For example, the dog training kit can be used to train puppies at home by a pet owner. The dog training kit provides all the necessary training tools in one handy place and within reach of the owner while training the dog. Moreover, the owner can wear the dog training kit, and thus, the owner's hands remain free.

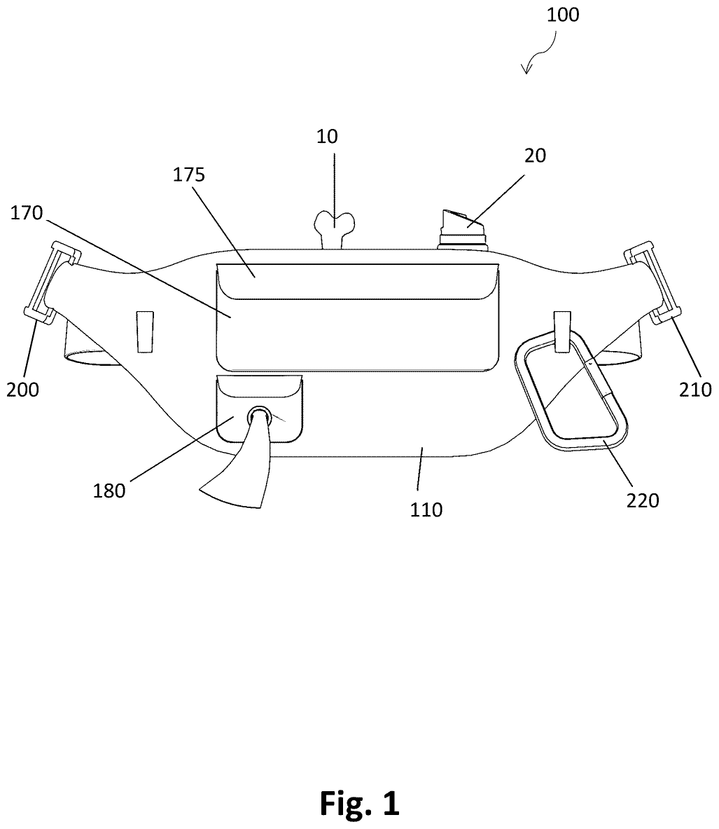

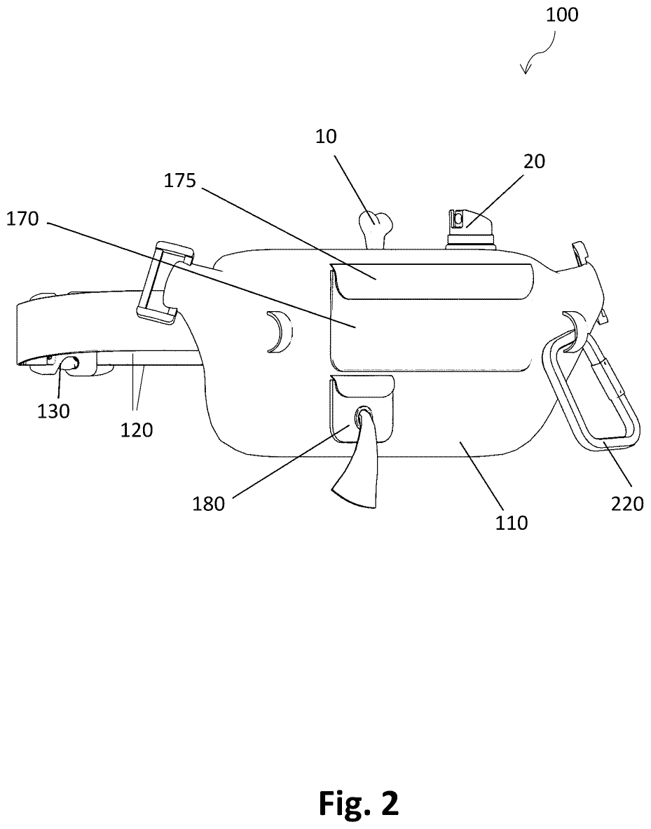

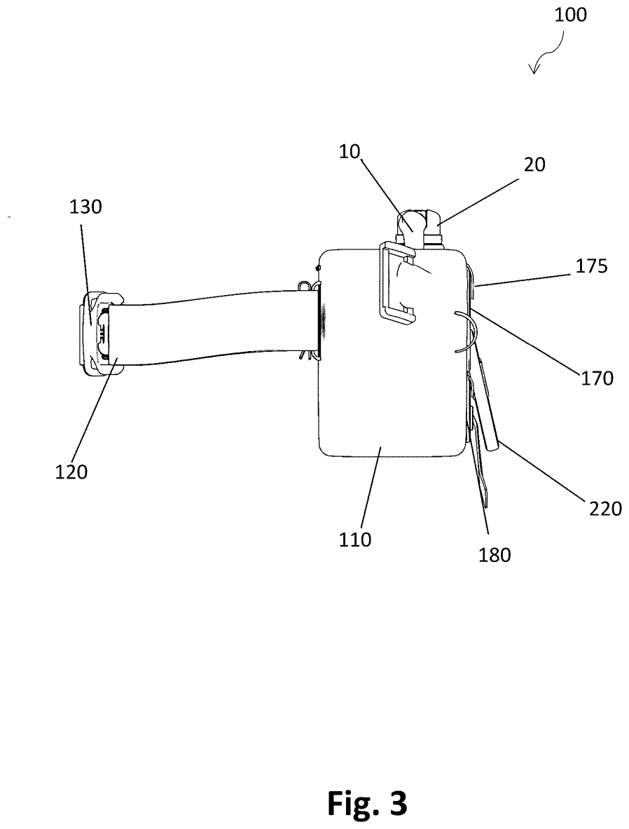

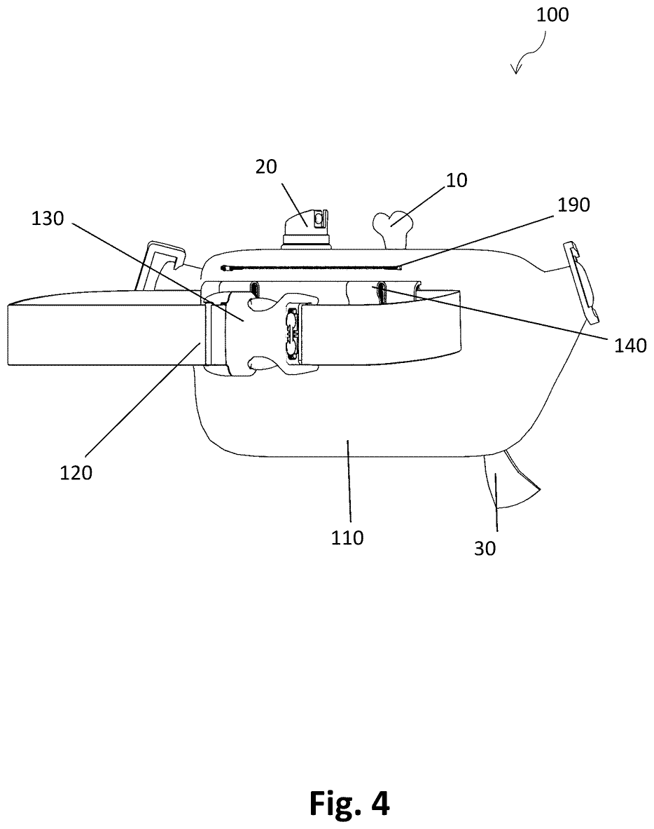

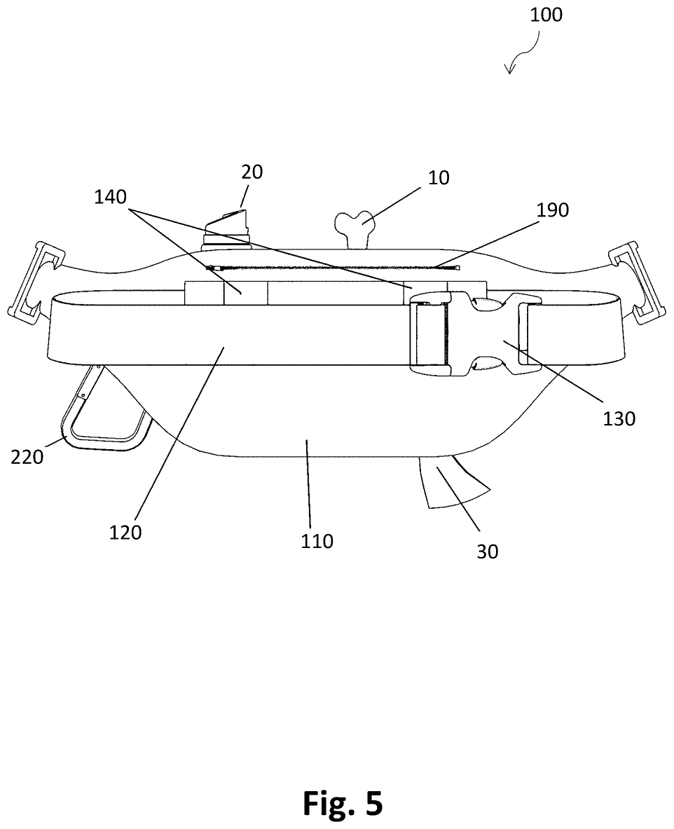

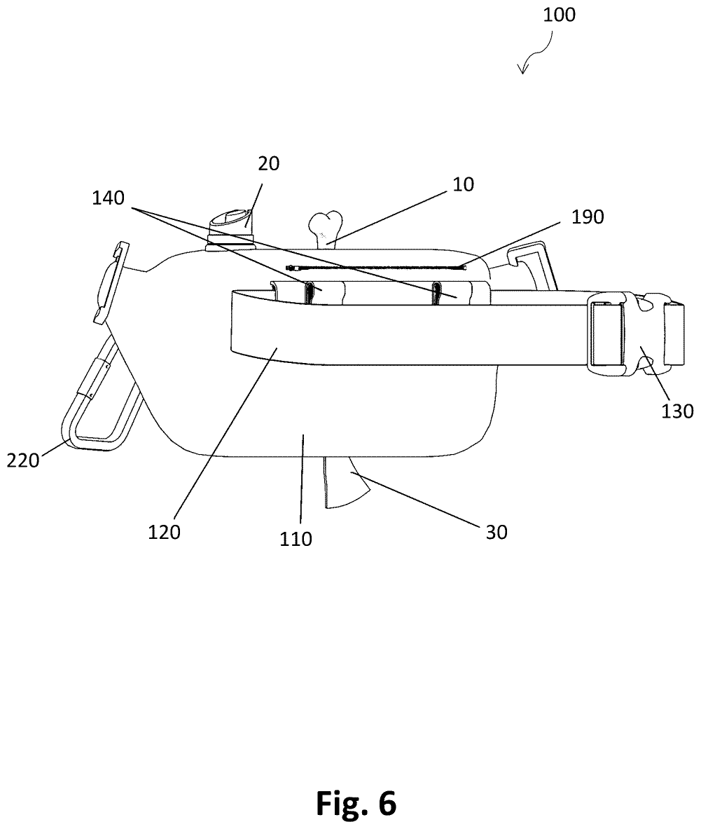

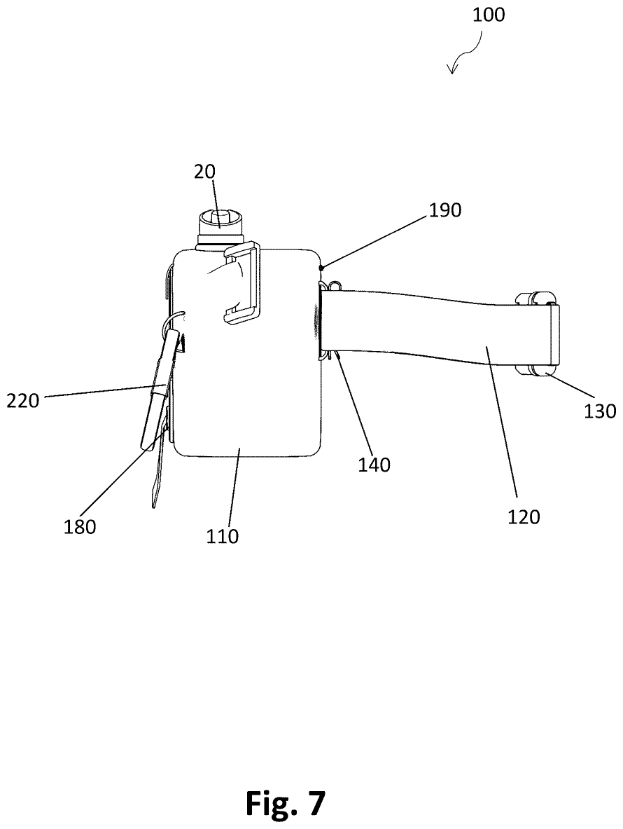

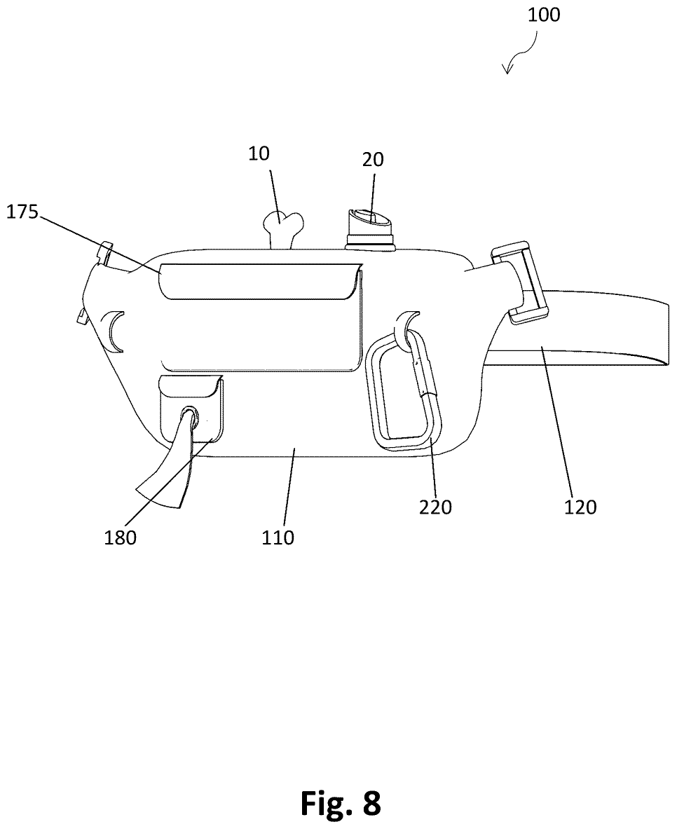

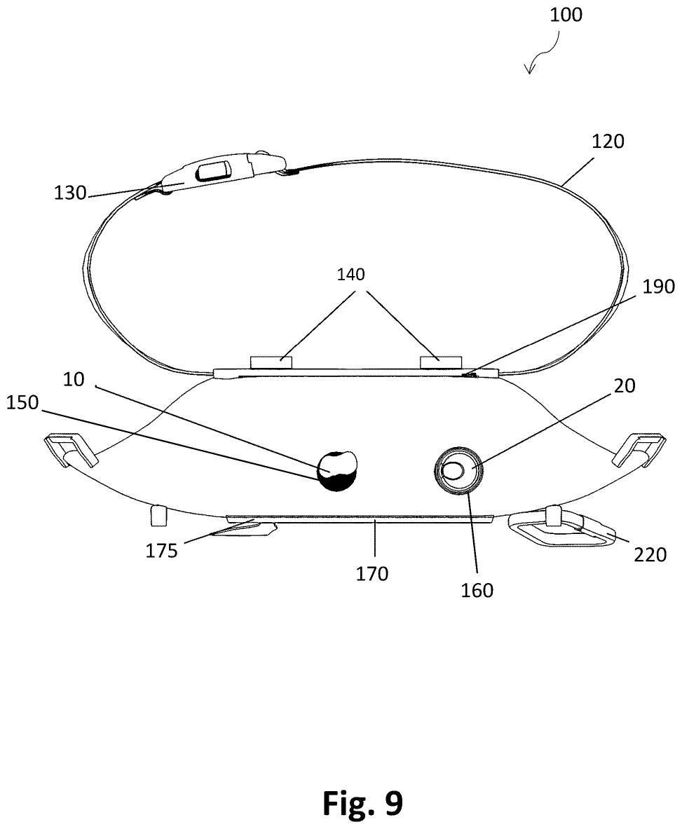

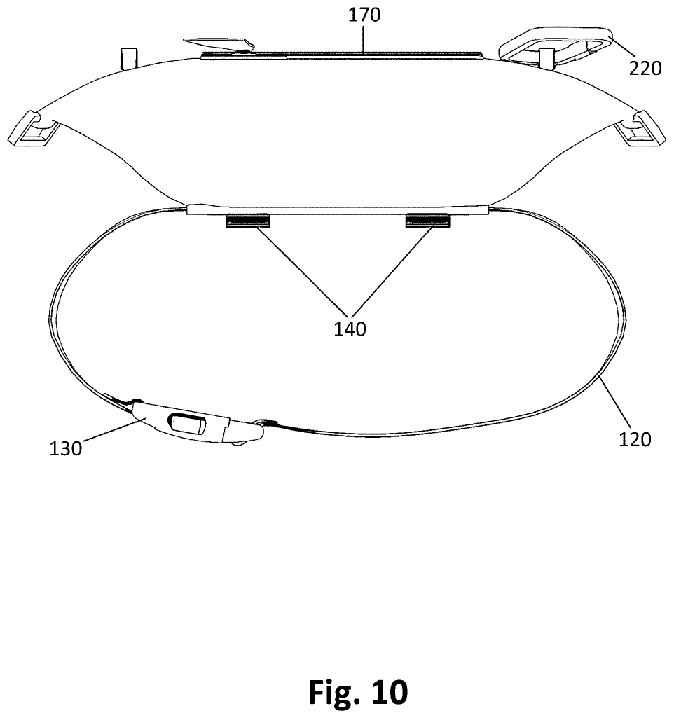

Referring to FIGS. 1-10 which show different views of the disclosed dog training kit. The dog training kit 100 includes a bag that is of an elongated and narrow profile that can be worn by a person. For example, the bag can be worn as a belt, over the waist. The bag has a proximal end and a distal end 110 along the length of the bag. An adjustable and removable strap 120 respectively extends from the proximal end and the distal end of the bag. The dog training kit may further include a fastener 130 that can be used to fasten the two straps together. The drawings show a quick snap fastener as the fastener 130. The strap 120 is adjustable in length to fit various waist sizes, or to be worn over one shoulder and across the body.

A first pocket 150 is provided on the top side of the bag and is an open pocket. The first pocket is specially sized to store a puppy-sized chew bone 10. As shown in the drawings, the bone extends upwards from the bag and can be quickly grasped by the Owner or Trainer. The first open pocket at the top of the bag allows the Owner or Trainer to quickly store or remove the bone. For example, a puppy-sized Nylabone®, which is a uniquely designed chew recommended by professional dog trainers, can be stored in the first pocket.

A second pocket 160, which is adjacent to the first pocket, is located on top of the bag body. This is also an open pocket allowing elongated can-like articles to be stored. The drawings show a can of compressed air 20 placed in the second pocket. This is an especially important compartment because it conceals the can enough to spray it and interrupt an unwanted behavior without removing it from the bag, thus not causing the dog to fear the can itself. A third pocket 170 is provided on the front side of the bag body. The third pocket is large and elongated to store treats that are used as rewards for good behaviors. The third pocket is closed by a magnetic flap 175. The use of a magnetic flap has the advantage that the pocket can be opened quickly by one hand, the same hand can be used to draw the treat, and the pocket can self-close to prevent treats from spilling out.

A fourth pocket 180 is provided on the front side and below the third pocket. The fourth pocket is smaller than the third pocket and has a magnetic closure to keep content secure. This pocket is used for storing excrement clean-up bags 30. The pocket has a hole through which a bag can be drawn like a tissue from a box.

A fifth pocket 190 is provided on the rear side of the bag body. This pocket closes with a zipper. The fifth pocket can be used to store personal items, such as a cell phone, credit cards, cash, keys, and the like.

The disclosed kit also includes a can of condensed air that makes a loud shoosh noise and interrupts unwanted behaviors. A detachable carabiner clip and roll of excrement clean-up bags can also be included.

To ensure the puppy owner takes advantage of all the features, the kit will also include an instruction/training tip booklet. Instructions include how to wear the bag, how to use the training tools, and many common training commands and techniques to train a dog.

Also, to secure the leash extending from a collar or harness of the puppy, a carabiner is attached to an anchor point is provided on two sides of the bag body. This allows securing the leash without occupying the hand of the user, allowing the Owner or Trainer to enjoy close and hands-free supervision. FIG. 1 shows the first loop 200 on the proximal end of the bag body, a second loop 210 on the distal end of the bag body, and a carabiner 220 can be attached to either loop on the bag body.

In use, an owner can wear the disclosed dog training kit using the straps around the waist or across the torso. The belt clips allow the dog training kit to be attached to the belt or pocket of the owner. The leash can be attached to the carabiner on one of the two anchor loops provided on the bag body. And when needed, the owner can quickly take out from or use a tool while stored in the bag. After use, the article or tool can be put back into the appropriate pocket of the bag. The tools or articles in the bag are well organized in multiple pockets, so the user does not have to search in the bag.

It is to be noted that the dog training kit is chiefly described for use in training puppies, however, it is understood that the dog training kit can be used with dogs of any age.

Thus, the disclosed dog training kit offers several advantages, such as speeding up all aspects of puppy training, alleviating the owner's frustrations of misplaced training tools within a split second of the dog's behavior, and conveniently holding all training tools plus personal items in one hands-free place. Moreover, the dog training kit can easily fit different users using belt clips and straps, i.e., one size fits all. The disclosed dog training kit is comfortable to wear around the house or while walking in public. In the bag, sufficient space can also be provided for a cell phone, money, credit cards, keys, etc. The disclosed dog training kit can also be used to promote products for Pet Owners to purchase.

Those people who wish to own a puppy but cannot do it because of the overwhelming task of training can use the disclosed dog training kit. The disclosed dog training kit can make the process of adding a puppy to the family exciting, and much less stressful. The kit helps speed up training and eliminate most frustrations and mistakes that most new puppy owners experience.

In certain implementations, disclosed is a dog training kit comprising a bag containing Training Guide (instruction sheet), one carabiner clip, a puppy-safe Nylabone (R), and a can of condensed air.

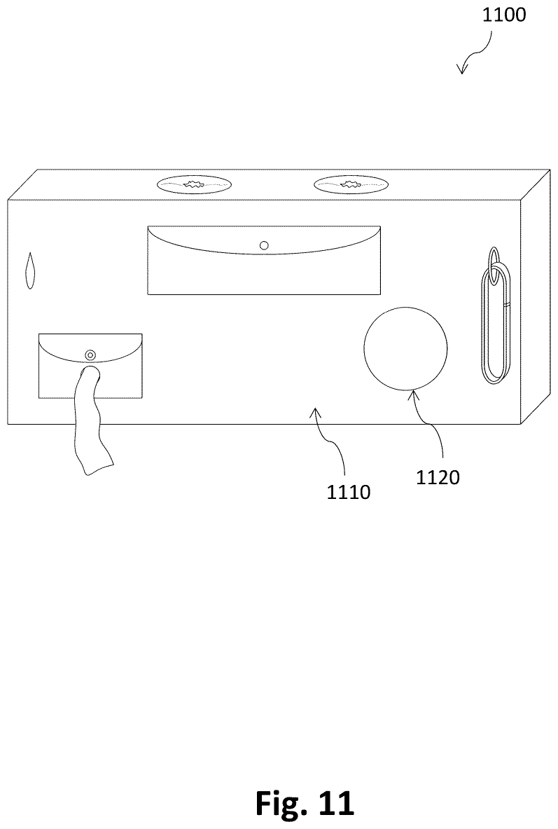

Referring to FIG. 11 which shows a preferred embodiment of the dog training kit according to the present invention. The dog training kit 1100 is almost same as the dog training kit 100 as explained above, however, the cuboid shape bag body 1110 offers more shape, and thus is advantageous. Also, the dog training kit 1100 does not have the first loop 200 and the second loop 210 as shown in FIG. 1. Space 1120 for logo is shown in FIG. 11. Such a variation of the dog training kit may be preferred; however, any such variations are within the scope of the present invention.

While the foregoing written description of the invention enables one of ordinary skill to make and use what is considered presently to be the best training mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A dog training kit comprising of:
a bag body of an elongated profile having a proximal end and a distal end along a length of the bag body;
five pockets disposed in the bag body;
a left strap extending from the proximal end of the bag body;
a right strap extending from the distal end of the bag body; and
a fastener for fastening the left strap and the right strap.

2. The dog training kit according to claim 1, wherein the five pockets comprise a first pocket configured in a top portion of the bag body, the first pocket is open and configured to receive a bone, wherein the dog training kit comprises the bone.

3. The dog training kit according to claim 2, wherein the five pockets comprise a second pocket configured in the top portion of the bag body, the second pocket is open and positioned adjacent to the first pocket and is configured to hold a can of condensed air, wherein the dog training kit comprises the can.

4. The dog training kit according to claim 3, wherein the five pockets comprise a third pocket configured on a front side of the bag body, the third pocket is configured to store treats for a pet, and the third pocket is closed by a magnetic flap.

5. The dog training kit according to claim 4, wherein the five pockets comprise a fourth pocket configured on the front side of the bag body, the fourth pocket is configured to store excrement clean-up bags, whereon the fourth pocket has a hole for drawing the excrement clean-up bags one at a time.

6. The dog training kit according to claim 5, wherein the five pockets comprise a fifth pocket configured on a rear side of the bag body, the fifth pocket is closed by a zipper.
